(19) United States
(12) Patent Application Publication
(10) Pub. No.: US 2014/0136571 A1
(43) Pub. Date: May 15, 2014

(54) System and Method for Optimizing Data Storage in a Distributed Data Storage Environment

(71) Applicant: ECOLE POLYTECHNIQUE FEDERALE DE LAUSANNE (EPF, Lausanne (CH)

(72) Inventors: Nicolas Bonvin, Chermingnon (CH); Athanasios Papaioannou, Lausanne (CH); Karl Aberer, Echandens-Denges (CH)

(73) Assignee: Ecole Polytechnique Federale de Lausanne (EPFL), Lausanne (CH)

(21) Appl. No.: 13/674,652

(22) Filed: Nov. 12, 2012

(51) Int. Cl. G06F 17/30

(52) U.S. Cl. CPC G06F 17/30318
USPC 707/792

(57) ABSTRACT

A growing amount of data is produced daily resulting in a growing demand for storage solutions. While cloud storage providers offer a virtually infinite storage capacity, data owners seek geographical and provider diversity in data placement, in order to avoid vendor lock-in and to increase availability and durability. Moreover, depending on the customer data access pattern, a certain cloud provider may be cheaper than another. In this respect is provided a method and a system that facilitates allocation of data objects in a distributed data storage environment. The system continuously adapts the placement of data based on its access patterns and subject to optimization objectives, such as storage costs. The system efficiently considers repositioning of only selected objects that may significantly lower the storage cost.

### FIELD OF THE INVENTION

The present invention relates to data storage in a distributed data storage environment. More specifically, the present invention relates to systems and methods for facilitating allocation of data objects in a distributed data storage environment.

### BACKGROUND OF THE INVENTION

Cloud providers are offering efficient on-demand storage solutions that can virtually scale indefinitely. Many public cloud storage providers are already available in the market, such as Amazon S3 (http://aws.amazon.com/s3), Google Storage (http://code.google.com/apis/storage), Microsoft Azure (http://microsoft.com/windowsazure) or RackSpace CloudFiles (http://rackspace.com/cloud) and one may expect new providers to appear in the coming years. The offers in terms of pricing among providers vary significantly and may change over time to adapt to the market. Choosing the best-suited or cheapest provider for the data implies knowing in advance the access pattern to the data. Data that is rarely accessed should be stored at a cloud provider mainly with a low storage price, regardless of its access prices. On the other hand, a very popular data may be hosted on a provider with attractive price for the outgoing bandwidth. In most cases, it is difficult to know in advance the access pattern of a data item, and therefore one needs an adaptive solution to choose the most cost-efficient provider.

However, finding a suitable provider based on the access pattern of the data is not enough. A provider may end its business or suddenly increase its pricing policy. There exist many other technical as well as non-technical (e.g., boycotting a provider) reasons a user may want to change its provider. Therefore, in order to safely host its data and minimize the impact of the migration to a new provider, a user needs to proactively avoid vendor lock-in (i.e., being dependent on a specific service vendor with substantial switching costs) and ensure high durability and availability by geographic diversification of the data placement (e.g., the recent Amazon outage reminds us not to put all eggs in one basket, see hhtp://aws.amazon.com/message/65648).

In “RAGS: A Case for Cloud Storage Diversity”, Proc. Of SOCC, Indianapolis, USA, 2012, Abu_Iidbeh et al. underline the advantages of splitting a data object (e.g., a file) into chunks and storing them across several storage providers, in order to reduce costs and avoid vendor lock-in.

However, a more adaptive approach is required to cope with dynamically changing conditions, such as varying data access patterns, evolving pricing policies, new providers arrival, as well as providers' bankruptcy. Moreover, different data access patterns result in different optimal sets of providers in terms of charging.

### SUMMARY OF THE INVENTION

A first goal of the invention is to provide a system and a method that facilitates allocation of data objects in a distributed data storage environment, said environment comprising several data storage providers, by continuously adapting the placement of data based on its access pattern and subject to optimization objectives.

A second goal of the invention is to provide a system and a method that adapts the placement of data in a distributed data storage environment so as to minimize the storage cost.

A third goal of the invention is to provide a system and a method that adapts the placement of data in a distributed data storage environment so as to minimize the dependence from a specific data storage provider, in other terms so as to minimize the vendor lock in.

A fourth goal of the invention is to allow adaptive data placement based on the real-time data access patterns, so as to minimize the price that the data owner has to pay to the cloud storage providers while taking into account a set of customer rules related to data availability, data durability, latency for performing operations on data objects stored in a distributed data storage environment, etc.

Other optimization goals for data placement are also conceivable, such as maintaining a certain monthly budget by relaxing some constraints, such as lock-in or availability, or minimizing query latency by promoting the most high-performing providers.

A fifth goal of the invention is to provide a system and a method that adapts the placement of data in a distributed data storage environment comprising a non-static set of public cloud and corporate-owned private storage resources.

A sixth goal of the invention is to provide a robust distributed architecture that is able to handle a large number of objects stored, which are accessed by a large number potential user.

A seventh goal of the invention is to provide a brokering service that can provide assistance to data owners with respect to storage of data objects in a distributed data storage environment comprising several data storage providers.

According to the invention, a system that facilitates allocation of data objects in a distributed data storage environment, said environment comprising several data storage providers, comprises:
at least one processor that executes computer-executable code stored in memory to effect the following:
   means for specifying at least one data object to be stored in said distributed data storage environment;
   means for performing a treatment on said data object;
   means for defining a first set of data related parameters;
   means for collecting periodically access related information with respect to said data object;
   means for building a second set of data related parameters, distinct from said first set of data related parameters, by making use of said access related information;
   means for memorizing said first set of data related parameters and said second set of data related parameters; and
   means for computing periodically, using said first set of data related parameters and said second set of data related parameters, an allocation plan for said data object, wherein said allocation plan identifies at least one corresponding data storage provider of said distributed data storage environment for storing said data object.

According to the invention, said means for defining a first set of data related parameters can comprise an interface that allows a user to specify desired data related parameters and provider related parameters.

According to the invention, said means for defining a first set of data related parameters can comprise means for retrieving automatically provider related parameters from said distributed data storage environment.

According to the invention, said means for collecting periodically access related information can comprise means for detecting changes in access patterns with respect to said data object.

According to the invention, said means for collecting periodically access related information can comprise means for dynamically updating a period on which said access related information is collected.

According to the invention, said means for building a second set of data related parameters can comprise means for computing access statistics with respect to said data object.

According to the invention, said treatment can retrieve attributes of said data object.

According to the invention, said treatment can classify said data object by making use of said attributes.

According to the invention, said treatment can divide said data object into several data chunks if several division criteria are fulfilled.

According to the invention, said treatment can predict an expected lifetime of said data object.

According to the invention, said desired data related parameters can include data durability related parameters, data availability related parameters, geographical related parameters and vendor lock-in related parameters.

According to the invention, said provider related parameters can include the cost for storing a certain amount of data, the upstream and downstream available bandwidth and the cost for performing operations on stored data.

According to the invention, the system can further comprise means for caching data so as to improve performance of read operations performed on data objects stored in said distributed data storage environment.

According to the invention, said allocation plan can minimize the cost implied by the storage of said data object in said distributed data storage environment and it can minimize the latency for performing operations on said data object.

According to the invention, said access related information can comprise the number of write operations and the number of read operations performed on said data object.

According to the invention, a method for facilitating allocation of data objects in a distributed data storage environment, said distributed data storage environment comprising several data storage providers, comprises:
employing a processor executing computer-executable instructions stored on a computer-readable storage medium to implement the following acts:
   providing an interface for allowing specification of at least one data object to be stored in said distributed data storage environment;
   performing a treatment on said data object;
   defining a first set of data related parameters;
   collecting periodically access related information with respect to said data object;
   building a second set of data related parameters, distinct from said first set of data related parameters, by making use of said access related information;
   memorizing said first set of data related parameters and said second set of data related parameters; and
   computing periodically, using said first set of data related parameters and said second set of data related parameters, an allocation plan for said data object, wherein said allocation plan identifies at least one corresponding data storage provider of said distributed storage environment for storing said data object.

According to the invention, said act of defining a first set of data related parameters can comprise the act of retrieving automatically provider related parameters from said distributed data storage environment, said act of collecting periodically access related information can comprise the act of detecting access patterns changes with respect to said data object and the act of dynamically changing a period on which access related information is collected and the act of building a second set of data related parameters can comprise the act of computing, by making use of said access related information, access statistics with respect to said data object.

According to the invention, the first set of data related parameters can include data durability related parameters, data availability related parameters, geographical related parameters and vendor lock-in related parameters.

According to the invention, a system that provides assistance to data owners with respect to the storage of data objects in a distributed data storage environment comprising several public and private data storage providers, comprises an interface that allows data owners to specify data objects to be stored in said distributed data storage environment and data objects related parameters, means for computing an allocation plan for said data objects that optimizes the cost implied by the storage of said data objects in said distributed data storage environment, means for collecting periodically information about access patterns with respect to each one of said data objects and means for triggering periodic computation of said allocation plan by making use of said information.

A software according to the invention, when ran on a computer, provides assistance for allocating data objects in a distributed data storage environment in order to minimize the storage cost and allows to be performed at least one functionality selected from a group consisting of: performing operations on data objects stored in said distributed data storage environment, computing periodically an allocation plan for said data objects, said allocation plan identifying one or more selected data storage providers of said data distributed storage environment for storing said data objects, enabling automatic transfer of data objects in accordance with said allocation plan and triggering periodic computation of said allocation plan.

Other advantages and novel features of the claimed subject-matter will become apparent from the following detailed description of the innovation when considered in conjunction with the drawings.

### BRIEF DESCRIPTION OF THE DRAWINGS

FIG. 1 illustrates the concept of erasure coding (m,n).

FIG. 2 illustrates Example of storage rules.

FIG. 3 illustrates example of providers' related parameters.

FIG. 4 illustrates the architecture of the system according to the present invention.

FIG. 5 shows graphics illustrating the time left to live for a class of objects containing 20 objects, whose lifetime varies from 0 to 6 hours.

FIG. 6 illustrates statistics used to improve the first placement of a data object.

FIG. 7 illustrates the process of periodic optimization.

FIG. 8 illustrates the trend detection process using a threshold limit of 0.1, a sampling period of 1 hour and a decision period of 1 day.

FIG. 9 illustrates the trend detection process using a threshold of 0.1, a sampling period of 1 day and a decision period of 1 week.

FIG. 10 illustrates the concept of concurrent writes.

FIG. 11 illustrates examples of metadata for several data objects.

### DETAILED DESCRIPTION

In the following is described a system and a method according to the invention that facilitates allocation of data objects in a distributed data storage environment comprising a non-static set of public and private data storage providers. In the following, a data object can be any kind of electronic data (text file, image file, executable code, backup data, etc.). The size of a data object is not limited. It can vary from one kilobyte to several terabytes and depends on the configuration environment of the system. A data object is defined in the following as comprising at least one data chunk where a data chunk is simply a chunk of electronic data. The precise size of a data chunk is not limited and depends also on the configuration environment of the system. The system and method according to the invention facilitates allocation of data objects in a distributed data storage environment so as to fulfill various optimization criteria, such as to minimize the storage cost while minimizing also the vendor lock in.

A “vendor lock in” situation indeed happens when a customer, for switching from a service provider to another, has to face substantial switching costs which render the switching procedure too costly.

In order to store data objects in a distributed data storage environment so as to avoid vendor lock-in, data has to be hosted by multiple storage providers. However, despite being simple and reactive, storing full replicas of the same data is too costly.

With the aid of erasure coding (m, n), as described by Dimakis et al. in “Network Coding for distributed Storage Systems”, IEEE Transactions on Information Theory, Vol. 56, Issue 9, September 2010, a data can be split into n chunks (n>m), where any m-subset is sufficient to reconstruct a complete copy of the data. The rate r=m/n<1 of an erasure code is the fraction of chunks required to rebuild the original data. The disk space needed to store an r-encoded object increases by a factor of 1.

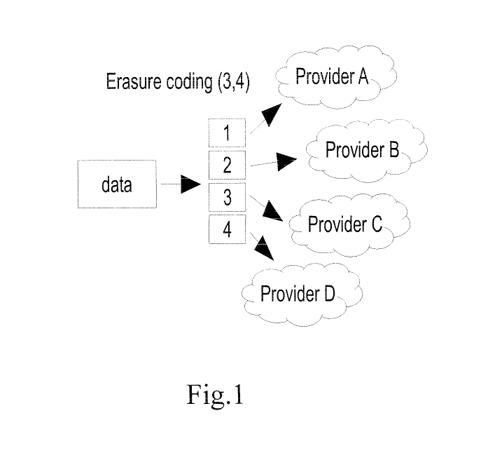

As depicted in FIG. 1, the original data can be rebuilt with the chunks stored at any 3 of the 4 cloud providers. For example, RAID 1 (mirroring without parity or striping) can be achieved by setting m=1, while RAID 5 (block-level striping with distributed parity) can be described by (m=k, n=k+1), where k 3.

Redundant striping presents several advantages. First, it allows to tolerate up to n−m provider outages, hence greatly improving the durability as well as the availability of the stored data. The user may also choose how to recover from a provider failure. One might decide to reconstruct the missing chunks from the other providers and store them to new providers, or on the other hand, one might decide to ignore the failure and wait for the provider to recover. Second, striping provides a finer granularity than full replication, which permits to read from the cheapest provider or to move a restricted number of chunks to a cheaper provider. Also, it gives a better control on the cost by allowing to store and serve data from public providers as well as private storage facilities.

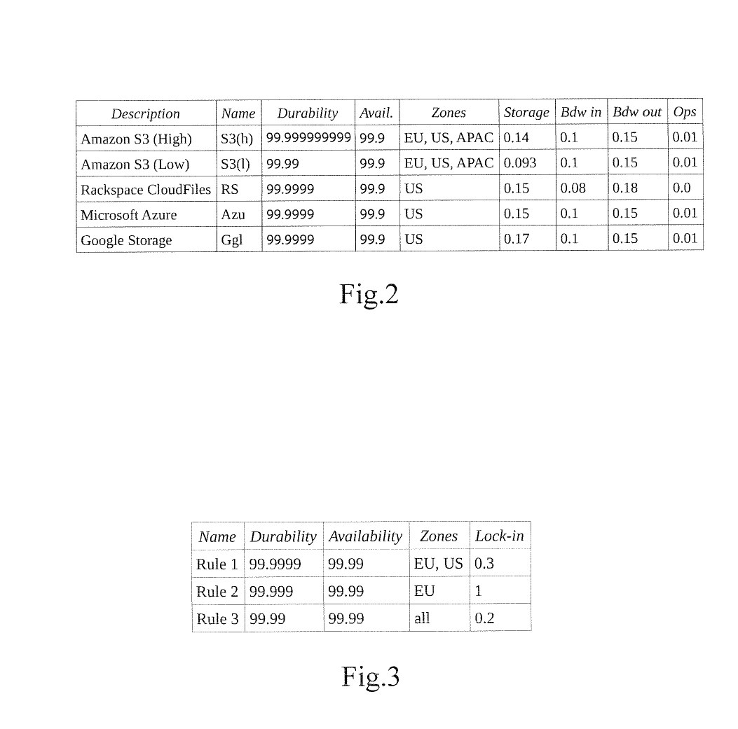

Given customer (i.e., data owner/producer) requirements (possibly differentiated per data item), such as data durability, data availability or independence from cloud providers to avoid vendors lock-in, it then becomes a non-trivial task to find the cloud storage provider(s) or combinations of cloud storage providers that offer the best price to store users' data. To make things worse, the ratio of read/write operations of a data object over a period of time (i.e., the data access pattern) affects the resulting charging for the customer, as providers implicitly promote certain access patterns with their pricing policies. In this respect, FIG. 2 shows, with respect to several data storage providers, the prices in USD per GB (Giga Bytes) for storage, bandwidth in (downstream), bandwidth out (upstream) or in USD for 1000 requests for performed operations.

The present invention provides a system that optimizes the placements of data chunks following the rules set by the data owner, while also taking into account the access patterns of the data in order to compute the cheapest provider set. A default rule, rules per data object classes or rules per data object can be defined in the system according to the present invention (e.g., using an API or a Web interface), so as to specify the availability, the durability, the geographical zone(s) and the lock-in factor of the data, as described in FIG. 3. The lock-in factor obj[lockin]ε(0, 1] of a data object obj is defined as:

obj[lockin]=1/N_{obj},

where N_{obj} is the number of minimum distinct providers where the data object obj will be stored.

Given the users' rules, the system according to the present invention stores the user data at the cheapest provider set among the complete range of possible alternatives, and continuously adapts the data placement to match the data access pattern. For example, a user looking to store non-critical and ephemeral data will not be interested in avoiding vendor lock-in or storing its data to a high durability provider. On the other hand, if one wants to store critical data over a long period of time, vendor lock-in as well as durability become serious issues. Cold data may be stored at providers offering the cheapest storage price, regardless of the price of bandwidth or of operations, while popular data should be stored to providers showing low prices regarding outgoing bandwidth. By only specifying simple rules, a user should be able to always pay a fair price according to his real needs.

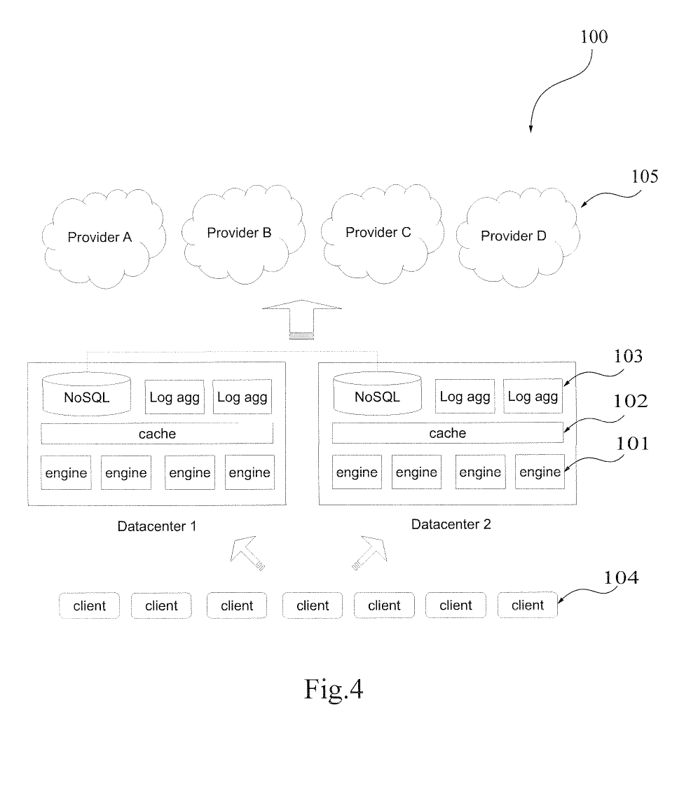

FIG. 4 shows a system 100 according to the invention that facilitates allocation of data objects in a distributed data storage environment comprising several data storage providers.

The system 100 according to the invention can run directly at the customer premises as an integrated hardware and software solution (i.e., an appliance) or can be deployed as a hosted service across several datacenters, putting the emphasis on providing a scalable and highly-available architecture with no single point of failure, able to guarantee higher availability than the storage providers.

In the example shown on FIG. 4, the appliance is located directly in the customer's data center, with the advantage of not introducing additional network latency, not having to pay any extra service fee and not being dependent on the availability of the hosted service. On the other hand, the system can also be implemented so as to be accessed as hosted service. In such a case, a customer does not need to install any additional hardware or software and will pay only service fees. The hosted service can also be operated by an independent broker for multiple customers through an online environment. In summary, the system according to the present invention can be implemented by making use of any combination of hardware and software means, it can be accessed by means of online or offline environments, and it can be deployed within a local or distributed environment. For the sake of simplicity, FIG. 3 shows a system according to the present invention as a hosted service in a setup consisting of only a pair of data centers. A client can send requests indifferently to each data center. Of course, the system according to the present invention can handle more than two data centers.

The system 100 according to the invention that facilitates allocation of data objects in a distributed data storage environment consists of three layers: a layer of stateless engines 101, a caching layer 102 and a database layer 103.

The engines 101 provide an Amazon S3-like interface (i.e. compatible to existing solutions employed by the end-users), where the users can put, get, list and delete their data using a key-value data model. The engines are responsible for computing the best provider set according to the user requirements, for maintaining the cost-effective data placement using the access history of the data, for splitting and storing the chunks at the most suitable providers, for reconstructing the data from the chunks and finally for deleting the data. Each engine works independently and does not keep a state. This allows this layer to scale linearly by just adding new engine components.

The caching layer 102 is not mandatory, yet if employed, it greatly improves the performance for read operations of popular data and reduces the corresponding costs for data fetching.

The database layer 103 is responsible for hosting the metadata of the data stored in the remote storage providers, and to store their access statistics.

A. Engine Layer

The engine acts as a proxy between the client 104 and the cloud storage providers 105, offering a unified API to all providers, including data storage to private resources. Mainly, it is responsible for storing the chunks of data to the best providers according to the optimization goals, and serving the data either directly from the cache or by reconstructing it using the chunks stored at the remote providers.

The engine also tries to maintain the optimality of the chunk placement of an object obj, by periodically recomputing the best provider set using the data access statistics of the last |Dobj| sampling periods, where D_{obj}⊂H_{obj} is referred to as decision period and corresponds to the period of historical access statistics used to compute the chunk placement that is expected to be optimal. The access statistics of a data object obj are kept in the history H_{obj}.

The sampling period s is a time period where the statistics per object are collected and aggregated, typically 1 hour. Knowing the recent access history of a data permits to precisely adjust the set of providers, as we can reasonably suppose that the access pattern of the data in the near future will be similar to the current. Choosing a large decision period allows to predict the access pattern farer in the future, and thus permits to make better placement choices in the long run. However, imagine that the chunks of a data object were placed based on the assumption that the object would be stored for at least 6 months, and the object was in fact deleted after 1 week. The chosen placement would have been probably wrong, resulting in higher costs for the end user. Thus, the decision period D_{obj} has to be dynamically adjusted as it depends on the lifetime of the object, the burstiness of its access pattern and the resulting economic impact of the latter.

In practice, it is determined based on a dichotomic search between 0 and min(TTL_{obj}, H_{obj}), where TTL_{obj} is the time left to live of the data object obj, as described below. When a periodic optimization procedure begins, historical access statistics of length D_{obj}/2, D_{obj}, and 2*D_{obj} are considered in parallel (i.e. coupling) when computing the best set of providers using Algorithm 1 (shown below). D_{obj} is then updated to the decision period based on which the cheapest set of providers is found among the three best sets. This approach for updating D_{obj} is applied every T optimization procedures. Initially, T=1 and whenever D_{obj} is found to be adequate, T is doubled, otherwise, T is reset to the initial value, i.e., T=1. The maximum value of T can be considered to be a period of weeks. Two approaches are considered to determine TTL_{obj}:a) An indication of the object lifetime may be provided by the end user at write time, allowing the system to make the best choices for chunk placement. b) Otherwise, the system employs statistics collected from all data objects to find out the most probable lifetime of a certain data item, as explained in the next subsection.

Algorithm 1 Get the best provider set for storing the chunks
of a data object obj using its access history H(obj)

| 1: price ← M AX_DOUBLE ; providers ← { } ; | |
|---|---|
| 2: threshold ← 0 ; combs ← { }{ } ; | |
| 3: combs ← getAllCombinations(P(obj)) ; | |
| 4: for all pset ∈ combs do | |
| 5: | lockin ← 1/\|pset\| |
| 6: | continue if lockin > obj[lockin] |
| 7: | th ← getThreshold(pset, obj[durability]) |
| 8: | continue if th ≦ 0 |
| 9: | av ← getAvailability(pset, th); |
| 10: | continue if av < obj[availability] |
| 11: | pr ← computePrice(pset, H(obj)) |
| 12: | if pr < price then |
| 13: | price ← pr |
| 14: | providers ← pset |
| 15: | threshold ← th |
| 16: | end if |

17: end for
18: return {providers, threshold}

1) Classification of Objects

An object belongs to a class of objects determined by its metadata such as size or MIME type. The class of an object C(obj) is derived using a simple hash of relevant metadata:

C(obj)=MD5(obj[mime]|discretize(obj[size]))

where discretize( ) is a function which rounds a number to a close integer (e.g., the size of an object is rounded up to the closest megabyte).

For every class of object, the system collects statistics regarding the resources used (i.e., bandwidth in and out, operations, deletion time, . . . ) and computes the lifetime distribution of the class, in order to dynamically assign a satisfying value for the decision period D_{obj} and to predict the lifetime of a new object at the time of insertion.

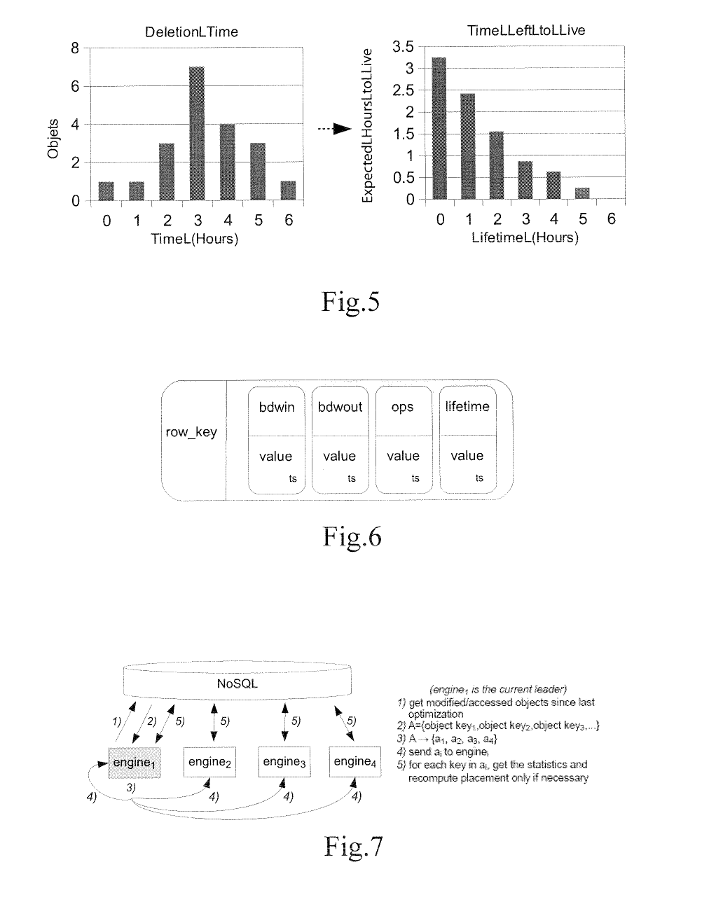

As it is shown in FIG. 5, given the deletion time of the objects of a certain class (left), one can compute the most probable time-left-to-live for an object (right). For example, at insertion time, the lifetime of an object of that class is expected to be 3.25 hours, while a 2 hours old object is expected to live for 1.55 hour more. The lifetime distribution of the classes of objects stabilizes after a training phase, and thus does not incur extra computing costs. The training phase should span the lifetime of some objects belonging to an object class. Initial training can be omitted and replaced by dynamic adjustment only, if initial estimates on the lifetime distribution of the object classes are known to the data owner. The statistics and distributions of the classes of objects are periodically refreshed using map-reduce jobs in the database layer.

2) Placement Algorithm

The time is divided into sampling periods. In current public cloud storage system, this period usually corresponds to 1 hour. For a sampling period s, at time i, statistics of a data object obj are collected, such as the used storage sᵢ[storage], the incoming bandwidth sᵢ[bwdin], the outgoing bandwidth sᵢ[bwdout] as well as the number of operations sᵢ[ops]. Let H(obj)={sₜ₋₀, sₜ₋₁, sₜ₋₂, . . . , s_{t-|Dobj|}} be the list of access history statistics of the data object at time t.

At insertion time, a data object has obviously no access history, and therefore the provider set chosen by the placement algorithm might change in a near future, when the data object has some accesses. Therefore, the system uses the statistics collected for the class of the object to determine the statistically best set of providers for this new object. Intuitively, a large archive file is most probably a backup, which will not be read often. On the other hand, a small image (such as a logo) will have plenty of read operations. The optimal set of providers for the aforementioned two examples will be different. Thus, thanks to the statistics collected for each class of objects, the probability that the first placement is already optimal increases. As depicted in FIG. 6, given row_key=C(obj), the placement algorithm has access to the most probable values regarding the resources that the new object obj will use and its lifetime, and therefore is able to make the best possible placement at this early point. Let P(obj)={pᵢ} be the set of storage providers (both public and private) available for storing the data object obj, with |P| being the total number of providers. A data object has to satisfy several properties contained in the service level agreement (SLA) with the user, such as the minimum durability obj[durability], the minimum availability: obj[availability] and the lock-in ratio obj[lockin]. Note that the algorithm is not restricted only to these user requirements.

Algorithm 1 (see above) describes how to compute the best provider set for storing the chunks of a data object obj based on its access history H(obj). The function getAllCombinations( ) returns the list of every combination of the |P| providers available for an object. Provider constraints in chunk size are taken into account in data placement as follows: two choices are evaluated in terms of expected price, namely inclusion of the constraining cloud provider (smaller chunks) vs. exclusion of the constraining cloud provider (larger chunks).

Algorithm 2 getThreshold( ) function: compute the largest threshold
given the set of providers pset and the required durability dr.

| Require: pset, dr | |
|---|---|
| 1: dura ← 0 | |
| 2: failuresOK ← −1 | |
| 3: combs ← { }{ } | |
| 4: while dura < dr && failuresOK < \|pset\| do | |
| 5: | failuresOK ← failuresOK + 1 |
| 6: | upP ← 0 |
| 7: | combs ← getCombinations(pset, f ailuresOK ) |
| 8: | for comb ∈ combs do |
| 9: | upP C omb ← 1 |
| 10: | for all p ∈ pset do |
| 11: | if p ∈ comb then |
| 12: | upPComb ← upPComb * (1 − p[durability]) |
| 13: | else |
| 14: | upPComb ← upPComb * p[durability] |
| 15: | end if |
| 16: | end for |
| 17: | upP ← upP + upPComb |
| 18: | end for |
| 19: | dura ← dura + upP |

20: end while
21: return |pset| − failuresOK

As described in Algorithm 2, the largest value of m for a set of providers is given by getThreshold( ), so as to satisfy the durability constraint of the object. Let us recall that having a value as large as possible for m, referred to as threshold, reduces the vendors lock-in and minimizes the storage overhead introduced by the erasure coding of the object. In Algorithm 2, starting from zero, the number of failed providers is increased until the durability constraint obj[durability] (dr in Algorithm 2) is no more satisfied by comparing dr with the probability that the object obj can be reconstructed from the non-failed providers according to the SLA durability of each provider. When the threshold is equal or less than zero, the set of providers is not able to satisfy the durability constraint. The function getAvailability( ) computes the availability of the object offered by the set of providers passed as parameter according to their SLA, in order to be compared with the minimum availability requirement obj[availability] of the object. The availability value av is obtained by computing the probability of the object to be successfully reassembled when up to th providers are unreachable. Finally, given the access history of an object, the function computePrice( ) returns the expected cost that a user may have to pay in the next decision period if the object is stored at the provider set taken as parameter.

3) Periodic Optimization

Recomputing the placement of every data item may become costly as the number of unique data objects can be very large (e.g., Amazon S3 is reported to store more than 339 billion objects as of June 2011). Iterating over all entries (i.e., a full table scan) is obviously not a scalable solution. Note that the provider set of an object will change only if its access history varies significantly or if the set of storage providers P(obj) changes. Therefore, detecting the changes of the access history pattern of the objects and only optimizing the placement of the objects that may have a new economically-efficient provider set greatly reduces the amount of work and resources needed to continuously ensure that every object is optimally placed. It also permits to run the optimization procedure often, so that the system reacts fast. Moreover, the operational and computational complexity of the placement optimizations should be kept as low as possible in order the solution to remain scalable when the number of managed objects increases.

Periodically (e.g., every 5 minutes), the system according to the invention starts the optimization procedure. This procedure is depicted on FIG. 7.

At time t, a new optimization procedure oₜ starts: a leader, elected among all engines from all datacenters, retrieves from the statistics database the set A={objᵢ} of object keys that have been accessed or modified after the last optimization procedure oₜ₋₁. The leader splits A into |E| subsets of equal size, where E={eᵢ} is the set of all engines from all datacenters. A subset aᵢ of keys is assigned to each engine eᵢεE. For every object key in aᵢ an engine eᵢ will determine whether the access history pattern of the object has changed or not, by using a detect( ) function described as follows: In order to detect a changing access pattern at time t, a statistics window of size w=3 sampling periods is employed. High values of w detect trend changes in long time scales, while small values of w should be employed for detecting frequent trend changes. The algorithm also takes as input a threshold limit (e.g. 10% was experimentally found to perform adequately), which is dynamically determined as the minimum momentum (i.e. change in the simple moving average) per object class that would result into a different best set of providers. Momentum is employed for trend change detection, but alternative approaches (e.g. regression models, neural networks, etc.) and other indicators (e.g. rate of change, stochastic indicator, etc.) are also possible.

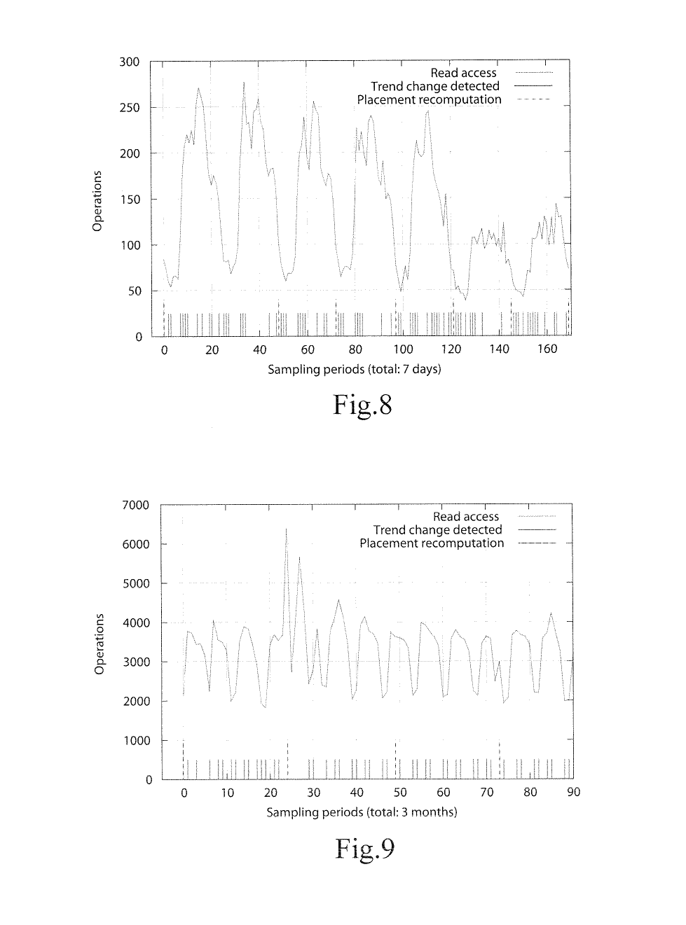

Only if the access history pattern has changed considerably (based on limit), the engine will recompute the placement of the object using Algorithm 1. If a better provider set is found and if the cost of migration is covered by the benefits of migrating to the new provider, it will migrate the chunks accordingly. The placement of objects with no access or a non-varying access pattern will not be recomputed. FIGS. 8 and 9 show when the object placement is recomputed, given a real website access pattern (the website has around 2500 visitors per day mainly coming from Europe (62%), North America (27%) and Asia (6%)).

As an engine itself is completely stateless and independent, adding more computing power is straightforward. Moreover, in order not to deteriorate the reactivity and the performance for handling the clients requests, the code per-forming the optimization process can easily be realized as a standalone service and can run on distinct servers.

B. Caching Layer

In order to improve the reactivity of the read operations, the system according to the present invention maintains a distributed (per datacenter) cache layer. Upon a data read, if the data is present in the cache, there is no need to fetch the chunks from the remote providers and reassemble the data object before serving it to the client. Otherwise, the data is reassembled from the chunks, served to the client and stored in the cache. Not only this layer reduces the requests latency, but it also reduces the interactions with the storage providers, resulting in lower costs for the user. In a multi-datacenter setup, the cache has to be invalidated in all datacenters in order to guarantee the consistency of the read operations. The caching layer can be combined and extended by a CDN to reach even better read performance.

C. Database Layer

The database layer of the system according to the present invention stores the metadata (i.e., the rules set by the end users regarding the durability, availability or vendor lock-in avoidance constraints of their data objects, the public provider settings, the settings of the users' private storage resources) as well as the access history of the data objects (i.e., the statistics). The database can be concurrently accessed by several engines updating the same entry, in all datacenters. As clients' requests are routed to all datacenters indifferently, the database has to be replicated; the classic master-slave replication scheme of traditional databases is not suitable for our multi-master setup, as the system according to the present invention has to keep working even when a data-center is down. Moreover, not only the read but also the write operations have to be scalable.

1) Concurrency and Conflicts

In a distributed system, a race condition can result in catastrophic situations where concurrent updates for the same entry can lead to data corruption or data loss. To deal with concurrency, two approaches are imaginable in the architecture of the system according to the invention. The first solution is to use a distributed locking mechanism to ensure that an entry is updated only by a single engine at a time. However, because of the multi-datacenter setup of the system, such distributed locking mechanism needs to be synchronized among the datacenters and results in higher write operation latency. Even worse, in case of a network partition between the datacenters, the locking mechanism is not able to form a quorum and assign locks. To solve this issue, a third party, monitoring all datacenters and assigning the role of a master to one datacenter is required in case of failure.

Multi version concurrency control (MVCC), as described in “Concurrency Control in Distributed Database Systems”, Bernstein et al., ACM Computing Surveys, 1981, is an alternative approach without locks, where an update operation does not delete the old data overwriting it with the new one. Instead, the old data is marked as obsolete and the new version is added, resulting in storing multiple versions of the data with only one being the latest. If an entry is updated concurrently in multiple datacenters, the database will detect the conflict (e.g., employing anti-entropy mechanisms such as vector clocks). The user will be prompted to decide which version is the good one and the system will remove the other version. Alternatively, the system can decide by itself to keep only the latest version without asking the end user, however it requires that each engine is time-synchronized (e.g. via NTP).

2) Statistics

The read and write accesses of an object are collected using a distributed and reliable service for efficiently collecting, aggregating, and moving large amounts of log data: a log agent residing at each engine continuously reads the logs containing the statistics of the requests handled by the engine, and sends them to one of the log aggregators. The latter collect and aggregate the logs before writing them to the database.

The placement algorithm also needs statistics about the objects managed by system to take pertinent decisions when there is no access history of new objects, or when it has to predict the deletion of an object in order to optimize its placement. Those statistics are obtained using map-reduce jobs on the database, so as to aggregate the statistics of each individual objects.

D. Life Cycle of Read and Write Operations

The system according to the present invention relies on multi version concurrency control (MVCC) to deal with concurrent updates and requires every engine to be time-synchronized (e.g., using NTP) in order to resolve conflicts.

1) Write Operation

During a write operation of an object obj, a user will provide at least the following input through the system interface: a container name obj[container], a key obj[key] and the data obj[data]. After having decided the optimal set of providers P (obj), system splits the data object into |P(obj)| chunks, and stores the latter at the selected storage providers using as key:

skey=MD5(obj[container]|obj[key]|UUID)

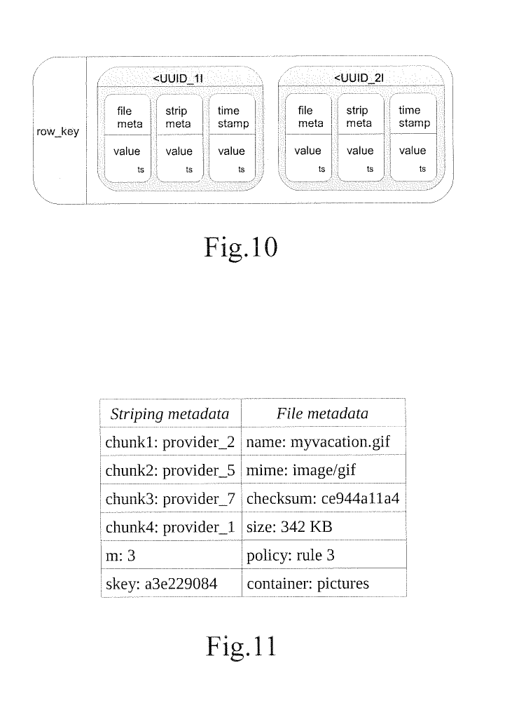

UUID is a globally unique identifier which prevents concurrent updates to cause data corruption. The metadata of obj is written to the database with UUID as the primary key, as depicted on FIG. 10.

As row key for writing the metadata, the system uses:

row_key=MD5(obj[container]|obj[key])

FIG. 11 shows an example of metadata stored for an object.

If the write operation is an update, older metadata corresponding to obj is discarded and the corresponding chunks deleted from the providers. The operations are logged and will be processed by the distributed log system, in order to be written in the statistics database. When a conflict is detected by the database in case of concurrent writes, the timestamps are compared, and only the freshest version is kept; the deprecated version of the object is removed from the storage providers and from the statistics database. Note that writing the statistics never conduct to conflicts in the database thanks to an adapted data model, where statistics are always written using globally unique keys.

2) Read Operation

To read an object obj, the end user sends a request to the system API with the container name and the object key as parameters. The randomly chosen engine that has received the request checks first if the data is in the cache. If so, then the data is directly returned from the cache. Otherwise, the engine reads the metadata of obj from the database, retrieves the m out of |P(obj)| chunks from the cheapest (other criteria can be considered) providers, reassembles the data and sends it to the client. The data is also stored in the cache. The operations are logged and stored in the statistics database.

3) Error Handling

At the providers' side: it may happen that one of the storage providers is not available. If it happens during a write operations, the system will choose the best placement that does not include the faulty provider. In case of a read operation, if |P(obj)|>m, then the data can still be retrieved from the m storage providers available. Recall that m corresponds to the minimum amount of chunks needed to reconstruct a data item. Finally, for a delete operation, the deletion of the chunk residing at a faulty provider is postponed until the provider recovers. As the system employs the MVCC approach, incomplete operations do not introduce inconsistencies.

At the system side: within a single datacenter, no layer has a single point of failure. In a multi-datacenter setup, where requests are routed indifferently to each datacenter, the database layer might cause a problem. In fact, thanks to an advanced support of multiple datacenters, the database layer automatically stores a replica in multiple datacenters. Therefore, read requests sent to the system API can always be served. Regarding write requests, as long as a single database node is up and running, no operation will fail, and when the second datacenter recovers, the replicas in the various datacenters will be eventually consistent.

E. Private Storage Resources

An interesting property of the system according to the present invention is the ability to use private storage resources together with commercially available public cloud storage solutions. Corporate storage resources (workstations, servers, NAS. SAN, etc.) or dedicated servers can be registered to the system with a description of their properties: amount and price of available storage, price of incoming and outgoing bandwidth and price per operation.

Alternatively, the system can retrieve automatically such properties from the data storage environment. For example, one can imagine that a data storage provider, private or public, provides information (storage price, upstream available bandwidth, downstream available bandwidth, etc) via a predefined API. The system according to the invention can also implement means for retrieving automatically the provider's settings.

The placement algorithm will take into account these new resources to minimize the costs of storing and serving the user's data. Thanks to unified interface of the system according to, it is straightforward to use local resources up to their capacities, and then use the best suited provider(s) when demand grows.

In order for a private storage resource to be accessible from the system, a standalone web service needs to be deployed locally on the resource. The web service is a lightweight and standalone web server that offers an authenticated Amazon S3 compatible REST interface to store and retrieve files. The data is stored on the local filesystem or on any distributed/parallel filesystem accessible directly from the web service and will never grow beyond the limit set in the properties of the resource. A private token generated by the private resource owner is also registered to the system, so that only legitimate requests are considered by the web service. The authentication is done by signing the request (i.e., HMAC of the requests parameters using the private token) and to prevent replay attacks, a timestamp is also included in the request. If the data stored is sensitive, the web service can be configured to use SSL/TLS.

F. Miscellaneous

What has been described above includes examples of the claimed subject matter. It is, of course, not possible to describe every conceivable combination of components or methodologies for purposes of describing the claimed subject matter but one of ordinary skill in the art may recognize that many further combinations and permutations are possible. Accordingly the detailed description is intended to embrace all such alterations, modifications, and variations that fall within the spirit and scope of the appended claims.

In particular, the description above has presented the fact that a data object is divided in chunks which are then allocated one by one in the distributed data storage environment. It is however conceivable that a data object is not divided into chunks and allocated as a whole in the distributed data storage environment. The reason for not dividing an object can be defined by the user, determined according to the size of the data object or, for example, determined with respect to the importance of the data to be stored. The system/method according to the invention will thus consider a set of division criteria (e.g. availability, durability, popularity, budget constraints, response time constraints, etc.) to determine if a data object has to be divided or not. The allocation of a data object as a whole is then performed in accordance with the method according to the invention described above in a similar manner as this performed for a data chunk.

Furthermore and in regard to the various functions performed by the above described components, devices, circuits, systems and the like, the terms (including a reference to a “means”) used to describe such components is intended to correspond, unless indicated otherwise, to any component which performs the specific function of the described component (e.g., a functional equivalent), even though not structurally equivalent to the disclosed structure, which performs the function in the therein illustrated exemplary aspects. In this regard, it will also be recognized that the describe aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given particular application. Furthermore, to the extend that the term “includes,” and “including” and variant thereof are used in either the detailed description or the claims, these terms are intended to be inclusive in a manner similar to the term “comprising”.

What is claimed is:

1. A system that facilitates allocation of data objects in a distributed data storage environment, said distributed data storage environment comprising several data storage providers, said system comprising:
at least one processor that executes computer-executable code stored in memory to effect the following:
means for specifying at least one data object to be stored in said distributed data storage environment;
means for performing a treatment on said data object;
means for defining a first set of data related parameters;
means for collecting periodically access related information with respect to said data object;
means for building a second set of data related parameters, distinct from said first set of data related parameters, by making use of said access related information;
means for memorizing said first set of data related parameters and said second set of data related parameters; and
means for computing periodically, using said first set of data related parameters and said second set of data related parameters, an allocation plan for said data object, wherein said allocation plan identifies at least one corresponding data storage provider of said distributed data storage environment for storing said data object.

2. The system of claim 1, wherein said means for defining a first set of data related parameters comprise an interface that allows a user to specify desired data related parameters and provider related parameters.

3. The system of claim 1, wherein said means for defining a first set of data related parameters comprise means for retrieving automatically provider related parameters from said distributed data storage environment.

4. The system of claim 1, wherein said means for collecting periodically access related information comprise means for detecting changes in access patterns with respect to said data object.

5. The system of claim 1, wherein said means for collecting periodically access related information comprise means for dynamically updating a period on which said access related information is collected.

6. The system of claim 1, wherein said means for building a second set of data related parameters comprise means for computing access statistics with respect to said data object.

7. The system of claim 1, wherein said treatment retrieves attributes of said data object.

8. The system of claim 7, wherein said treatment classifies said data object by making use of said attributes.

9. The system of claim 1, wherein said treatment divides said data object into several data chunks if several division criteria are fulfilled.

10. The system of claim 1, wherein said treatment predicts an expected lifetime of said data object.

11. The system of claim 2, wherein said desired data related parameters include data durability related parameters, data availability related parameters, geographical related parameters and vendor lock-in related parameters.

12. The system of claim 2, wherein said provider related parameters include the cost for storing a certain amount of data, the upstream and downstream available bandwidth and the cost for performing operations on stored data.

13. The system of claim 1, further comprising means for caching data so as to improve performance of read operations performed on data objects stored in said distributed data storage environment.

14. The system of claim 1, wherein said allocation plan minimizes the cost implied by the storage of said data object in said distributed data storage environment and minimizes the latency for performing operations on said data object.

15. The system of claim 1, wherein said access related information comprises the number of write operations and the number of read operations performed on said data object.

16. A method for facilitating allocation of data objects in a distributed data storage environment, said distributed data storage environment comprising several data storage providers, the method comprising:
employing a processor executing computer-executable instructions stored on a computer-readable storage medium to implement the following acts:
providing an interface for allowing specification of at least one data object to be stored in said distributed data storage environment;
performing a treatment on said data object;
defining a first set of data related parameters;
collecting periodically access related information with respect to said data object;
building a second set of data related parameters, distinct from said first set of data related parameters, by making use of said access related information;
memorizing said first set of data related parameters and said second set of data related parameters; and
computing periodically, using said first set of data related parameters and said second set of data related parameters, an allocation plan for said data object, wherein said allocation plan identifies at least one corresponding data storage provider of said distributed storage environment for storing said data object.

17. The method of claim 16, wherein said act of defining a first set of data related parameters comprises the act of retrieving automatically provider related parameters from said distributed data storage environment, wherein said act of collecting periodically access related information comprises the act of detecting access patterns changes with respect to said data object and the act of dynamically changing a period on which access related information is collected and wherein the act of building a second set of data related parameters comprises the act of computing, by making use of said access related information, access statistics with respect to said data object.

18. The method of claim 16, wherein the first set of data related parameters include data durability related parameters, data availability related parameters, geographical related parameters and vendor lock-in related parameters.

19. A system that provides assistance to data owners with respect to the storage of data objects in a distributed data storage environment comprising several public and private data storage providers, said system comprising an interface that allows data owners to specify data objects to be stored in said distributed data storage environment and data objects related parameters, means for computing an allocation plan for said data objects that optimizes the cost implied by the storage of said data objects in said distributed data storage environment, means for collecting periodically information about access patterns with respect to each one of said data objects and means for triggering periodic computation of said allocation plan by making use of said information.

20. A software which, when ran on a computer, provides assistance for allocating data objects in a distributed data storage environment in order to minimize the storage cost and allows to be performed at least one functionality selected from a group consisting of: performing operations on data objects stored in said distributed data storage environment, computing periodically an allocation plan for said data objects, said allocation plan identifying one or more selected data storage providers of said data distributed storage environment for storing said data objects, enabling automatic transfer of data objects in accordance with said allocation plan and triggering periodic computation of said allocation plan.
